(19) United States
(12) Patent Application Publication
(10) Pub. No.: US 2007/0183405 A1
(43) Pub. Date: Aug. 9, 2007

(54) Distributed server function in a VoIP to telephony bridging network

(75) Inventor: James D. Bennett, San Clemente, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/398,959

(22) Filed: Apr. 6, 2006

Related U.S. Application Data
(63) Continuation-in-part of application No. 11/348,962, filed on Feb. 7, 2006.
(63) Continuation-in-part of application No. 11/348,814, filed on Feb. 7, 2006.
(63) Continuation-in-part of application No. 11/348,743, filed on Feb. 7, 2006.
(63) Continuation-in-part of application No. 11/386,586, filed on Mar. 22, 2006.

(51) Int. Cl. H04L 12/66

(52) U.S. Cl. 370/352

(57) ABSTRACT

An infrastructure that supports both Voice over Internet Protocol (VoIP) telephony via the Internet and Public Switched Telephone Network (PSTN) telephony via the PSTN includes a plurality of client telephony bridging devices communicatively couple to both the Internet and to the PSTN that are operable to bridge calls between the Internet and the PSTN. Server processing circuitry distributed among the plurality of client telephony bridging devices is operable to setup call bridging, to service call bridging, and to track subscribers to the system. In setting up call bridging, the distributed server processing circuitry services a call setup request from a calling voice terminal via the Internet or PSTN. The distributed server processing circuitry is operable to select a servicing telephony bridging device from the plurality of client telephony bridging devices and to enable bridging by such device(s).

### CROSS REFERENCES TO RELATED APPLICATIONS

This application is a continuation-in-part of the following co-pending applications:

1. Utility application Ser. No. 11/348,962, filed on Feb. 7, 2006, and entitled “TELEPHONE SUPPORTING BRIDGING BETWEEN A PACKET SWITCHED NETWORK AND THE PUBLIC SWITCHED TELEPHONE NETWORK”;

2. Utility application Ser. No. 11/348,814, filed on Feb. 7, 2006, and entitled “COMPUTING DEVICE SUPPORTING BRIDGING BETWEEN A PACKET SWITCHED NETWORK AND THE PUBLIC SWITCHED TELEPHONE NETWORK”; and

3. Utility application Ser. No. 11/348,743, filed on Feb. 7, 2006, and entitled “SET TOP BOX SUPPORTING BRIDGING BETWEEN A PACKET SWITCHED NETWORK AND THE PUBLIC SWITCHED TELEPHONE NETWORK”; and

4. Utility application Ser. No. 11/386,586, filed on Mar. 22, 2006, and entitled “SERVICE EXCHANGE IN A VoIP TO TELEPHONY BRIDGING NETWORK”, all of which are incorporated herein in their entirety for all purposes.

### BACKGROUND OF THE INVENTION

1. Technical Field of the Invention

This invention relates generally to communication systems and more particularly to Voice over Internet Protocol (VoIP) telephony and to Public Switched Telephone Network (PSTN) telephony.

2. Description of Related Art

Voice telephony has been known for many years. Initially, voice telephony was supported by dedicated conductors between telephones. Then, voice telephony was enabled by operators manually switching connectors to create and tear down circuits between telephones. As technology advanced, mechanical components performed the switching operations to create and tear down circuits between telephones. With advancing technology, computers and semiconductor components replaced the mechanical components to perform circuit switching duties. Networks created using this circuit-switched technology are generally known as the Public Switched Telephone Network (PSTN). Generally, the PSTN provides a circuit-switched, time-divided connection between telephones.

Packet data communications, such as those supported by the Internet, differ from circuit-switched communications. With packet data communications, a source device forms a data packet, transmits the data packet to a packet data network, and based upon a destination address, e.g., Internet Protocol (IP) address of the data packet, the packet data network passes the data packet to a destination device. As the Internet and other packet data networks grew in popularity, packet switched voice telephony was developed. One common type of packet switched voice telephony is Voice over Internet Protocol (VoIP) telephony. When VoIP telephony was first introduced, the data packet transmission latency of the Internet and of other servicing networks caused the quality of VoIP telephony to be significantly worse than that of PSTN telephony. Over time, packet data transmission latency of the Internet and of other servicing packet data networks has decreased. Now, VoIP telephony provides service quality equal to or better than VoIP telephony in many cases.

Recently developed VoIP telephony applications enable computer users to establish non-toll VoIP telephone calls across the Internet. Compared to PSTN telephony VoIP telephony of this type is significantly less expensive, particularly for overseas calls. However, only a limited number of people have a computer upon which this VoIP telephony application may be loaded and have Internet access of a quality that will support the VoIP telephony application.

In order to gain some advantages of VoIP telephony but still service consumers having PSTN telephones, VoIP telephony service providers typically deploy VoIP gateways. The VoIP gateways bridge communications between the PSTN (PSTN telephony call) and the Internet (VoIP telephony call). VoIP telephony service providers typically extract a toll for servicing a call via the VoIP gateway bridge, thus destroying in part the low cost attractiveness of VoIP telephony. Thus, a need exists for systems and methods of operations that overcome the shortcomings of these prior telephony systems.

### BRIEF SUMMARY OF THE INVENTION

The present invention is directed to apparatus and methods of operation that are further described in the following Brief Description of the Drawings, the Detailed Description of the Drawings, and the Claims. Other features and advantages of the present invention will become apparent from the following detailed description of the invention made with reference to the accompanying drawings.

### BRIEF DESCRIPTION OF THE SERVERAL VIEWS OF THE DRAWINGS

FIG. 1 is a system diagram illustrating an infrastructure constructed and operating according to an embodiment of the present invention;

FIG. 2 is a system diagram illustrating an infrastructure constructed and operating according to another embodiment of the present invention;

FIG. 3 is a block diagram illustrating a plurality of client telephony bridging devices and their interconnection to various telephony infrastructure components constructed and operating according to an embodiment of the present invention;

FIG. 4 is a flow chart illustrating the operation of distributed processing circuitry according to an embodiment of the present invention;

FIG. 5 is a block diagram subscriber and terminal information tracked by distributed processing circuitry according to an embodiment of the present invention;

FIG. 6 is a block diagram illustrating a client telephony bridging device constructed according to a first embodiment of the present invention;

FIG. 7 is a block diagram illustrating a client telephony bridging device constructed according to a second embodiment of the present invention;

FIG. 8 is a block diagram illustrating a client telephony bridging device constructed according to a third embodiment of the present invention;

FIG. 9 is an operational flow diagram illustrating a plurality of VoIP to PSTN telephony operations according to embodiments of the present invention; and

FIG. 10 is an operational flow diagram illustrating a plurality of PSTN to VoIP telephony operations according to embodiments of the present invention.

### DETAILED DESCRIPTION OF THE INVENTION

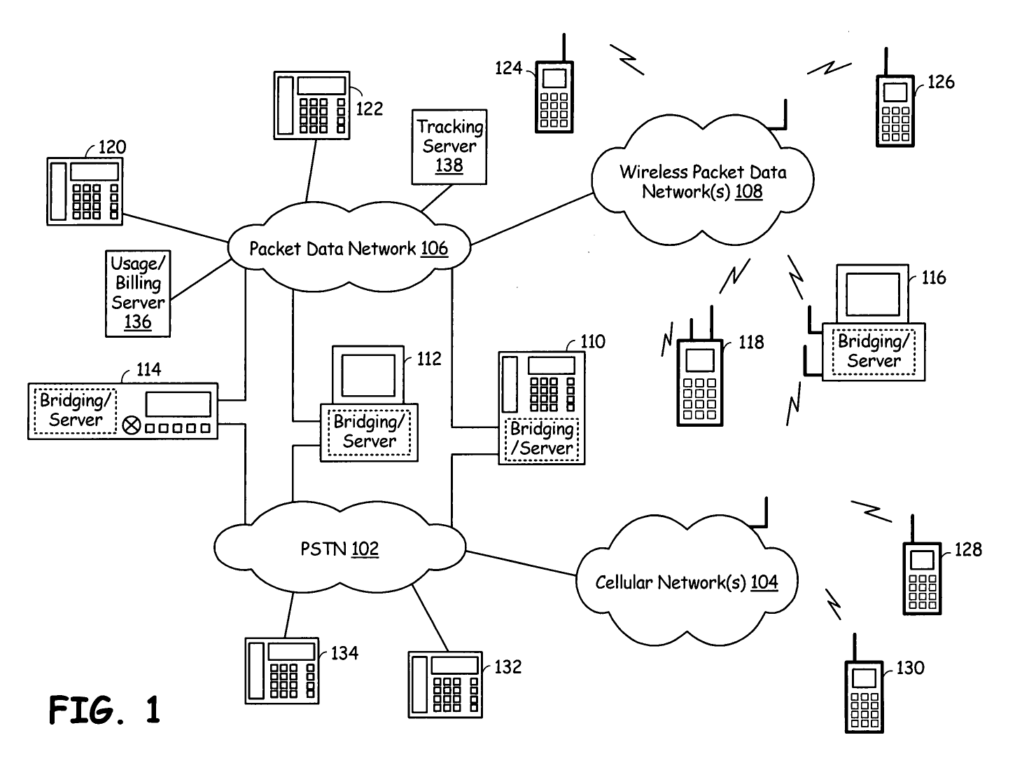

FIG. 1 is a system diagram illustrating an infrastructure constructed and operating according to an embodiment of the present invention. The infrastructure supports both Voice over Internet Protocol (VoIP) telephony via the Internet and Public Switched Telephone Network (PSTN) telephony via the PSTN. The infrastructure of FIG. 1 includes a plurality of client telephony bridging devices 110, 112, 114, 116, and 118 that communicatively couple to both the Internet and to the PSTN and that are operable to bridge calls between the Internet and the PSTN. Client telephony bridging device 110 has the structure of a telephone and couples to both wired packet data network 106 and wired PSTN 102. The wired packet data network 106 includes the Internet or coupling to the Internet. The structure and operation of the wired PSTN 102 is generally known and is employed to service conventional telephony applications. The wired packet data network 106 and a wireless packet data network 108 operate in a packet-switched manner while the wired PSTN 102 (and a cellular network 104, in some embodiments) operates in a circuit-switch manner.

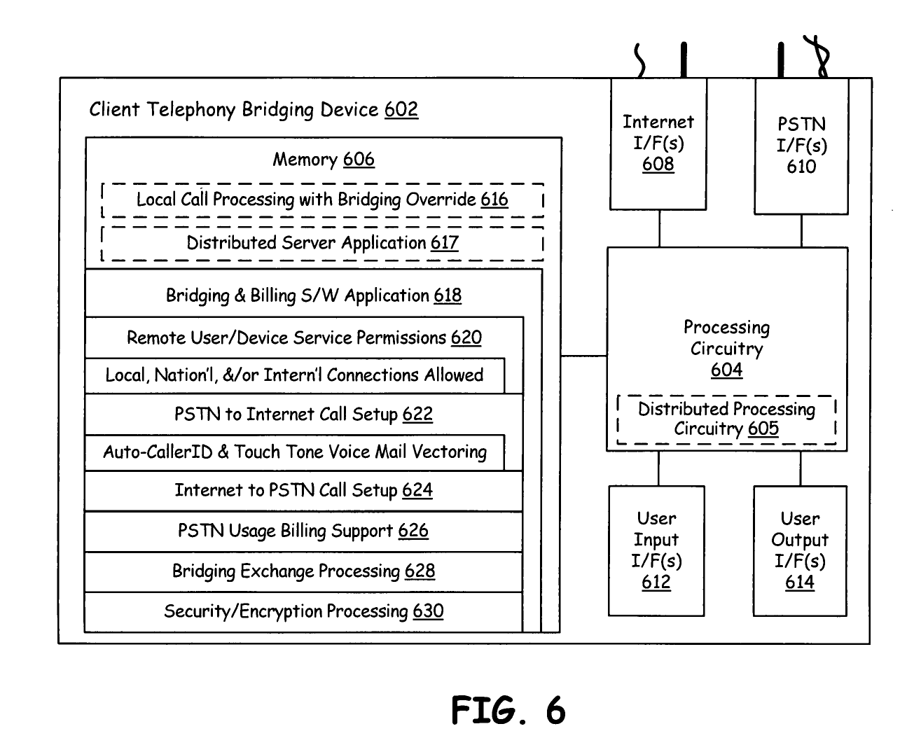

The structure of client telephony bridging device 110 will be illustrated further with reference to FIG. 6. Generally, client telephony bridging device 110 couples to the wired packet data network 106 via a wired connection such as a DSL connection, a cable modem connection, or another wired connection and couples to the wired PSTN 102 via a wired connection such as a twisted pair supporting conventional plain old telephone system (POTS) telephony, DSL, ISDN, or another conventional PSTN interface. Client telephony bridging device 110 includes bridging circuitry operable to bridge calls between the wired PSTN 102 and the wired packet data network 106 and includes a portion of distributed server circuitry constructed and operating according to the present invention.

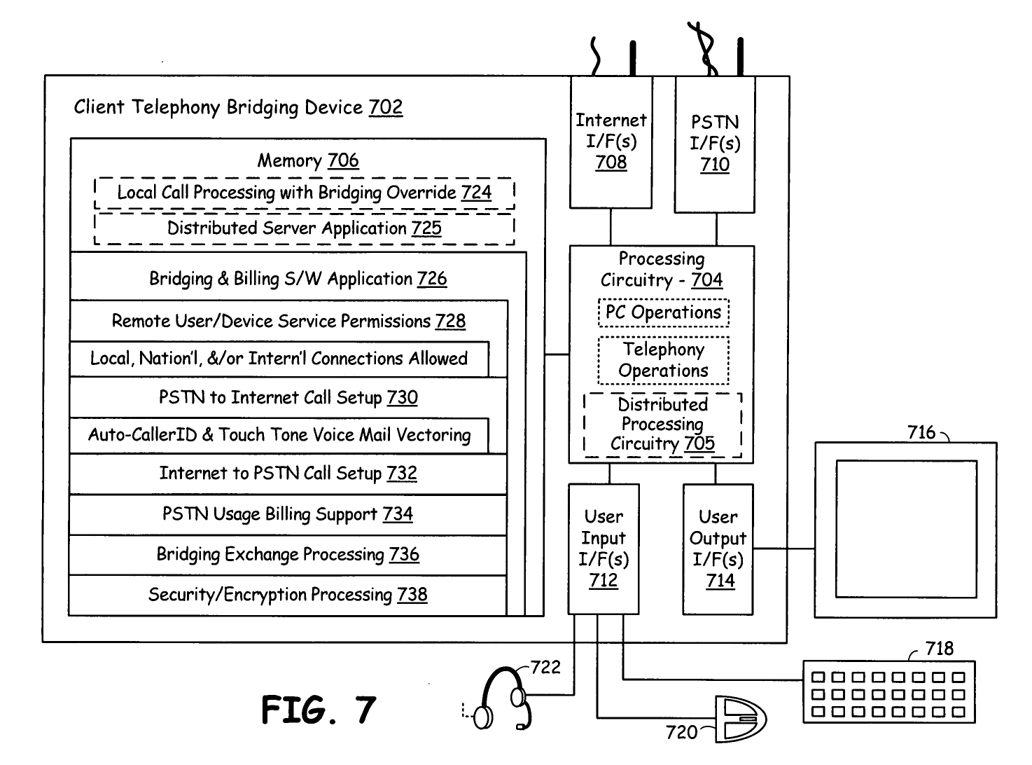

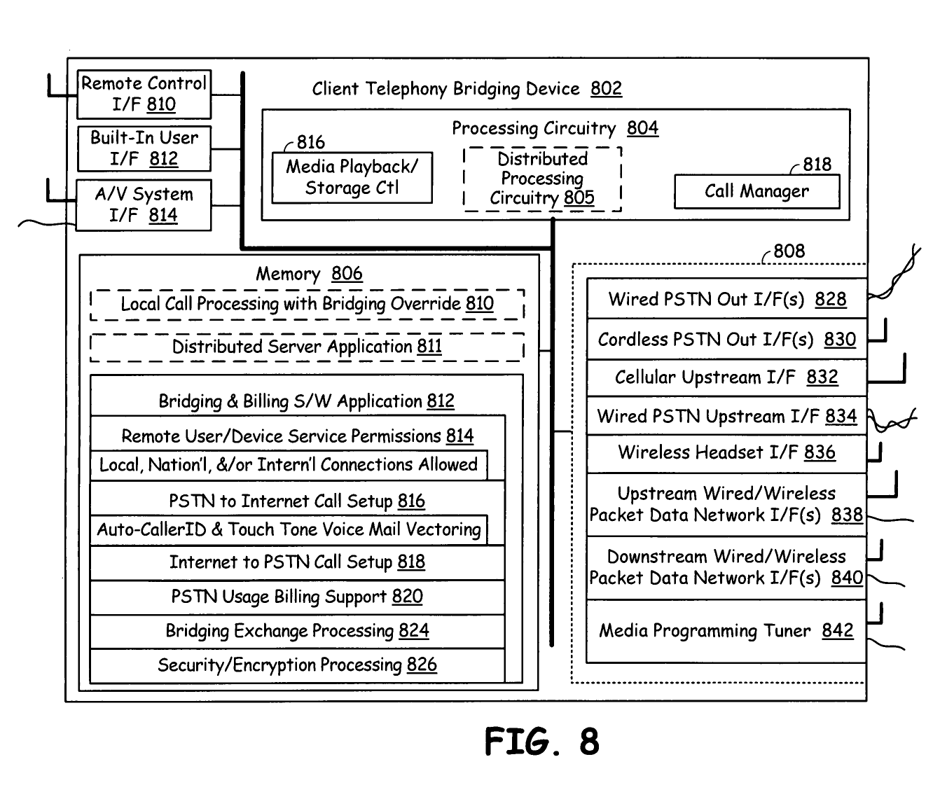

Generally, client telephony bridging device 112 has the structure of a personal computer that will be described further herein with reference to FIG. 7. Client telephony bridging device 112 couples to the wired packet data network 106 and to the wired PSTN 102 via connections same or similar as those servicing client telephony bridging device 110. Client telephony bridging device 112 includes bridging circuitry operable to bridge calls between the wired PSTN 102 and the wired packet data network 106. Client telephony bridging device 114 has the structure of a set-top box and will be described further herein with reference to FIG. 8. Generally, client telephony bridging device 114 includes bridging circuitry that is operable to bridge calls between the wired PSTN 102 and the wired packet data network 106. Further, in some embodiments, client telephony bridging device 114 may have wireless connections to wireless packet data networks 108 and/or to cellular networks 104. With this structure, client telephony bridging device 114 may also be operable to bridge calls between the cellular network(s) 104 and the wireless packet data network(s) 108.

Client telephony bridging device 116 has, generally, the structure of a personal computer and wirelessly couples to wireless packet data network(s) 108 and to cellular network(s) 104. The wireless connection between client telephony bridging device 116 and the wireless packet data network 108 may be a wireless local area network (WLAN) connection, a fixed wireless connection, a satellite network communication link, or another wireless link. The wireless connection between client telephony bridging device 116 and the cellular network 104 supports one or more cellular interface standards. Client telephony bridging device 116 is operable to bridge calls between the cellular network(s) 104 and the wireless packet data network(s) 108. The client telephony bridging device 116 communicatively couples to the Internet 106 via the wireless packet data network 108 and to the wired PSTN 102 via the cellular network(s) 104.

Client telephony bridging device 118 is operable to bridge calls between the cellular network 104 and the wireless packet data network 108. Client telephony bridging device 118 wirelessly couples to both the wireless packet data network(s) 108 and to cellular network(s) 104. The structure of client telephony bridging device 118 may be similar to that described with reference to FIG. 6.

Also shown in FIG. 1 are VoIP telephones 120 and 122, wireless VoIP telephones 124 and 126, cellular telephones 128 and 130, and PSTN telephones 132 and 134. These devices operate conventionally to service calls via their respective servicing networks.

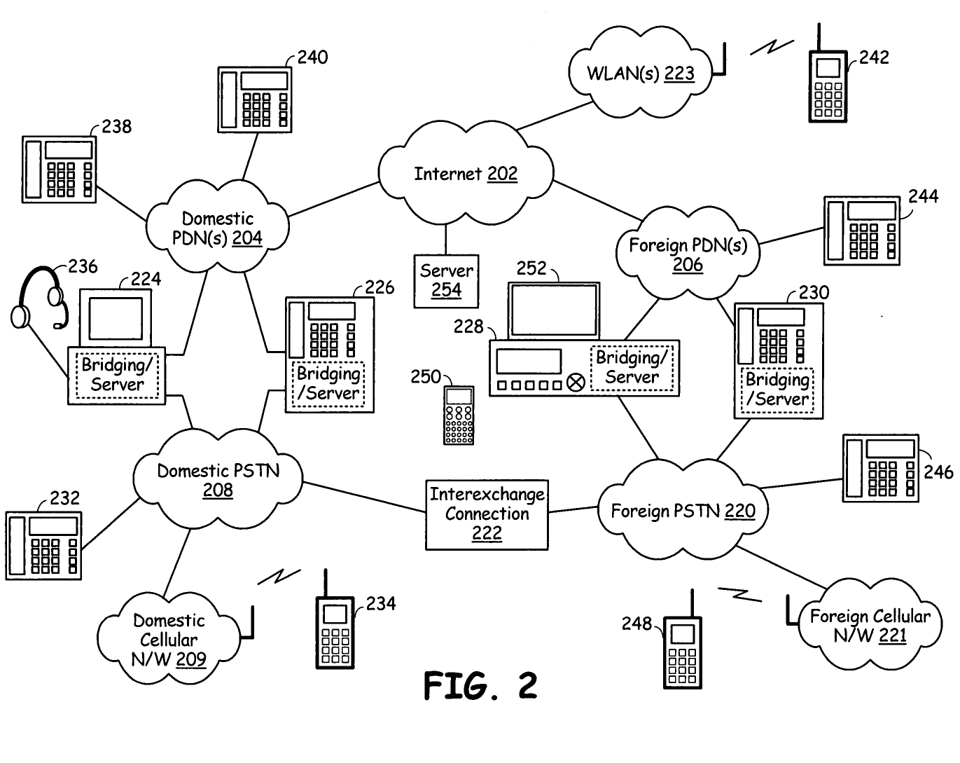

Each of the client telephony bridging devices 110-118 is operable to bridge a call between the Internet and the PSTN. Thus, each of the client telephony bridging devices 110-118 is operable to bridge a call between a VoIP terminal and a PSTN terminal, e.g., for VoIP terminal 122 and PSTN telephone 132. Bridging according to the present invention operates without requiring use of a conventional VoIP gateway that would be deployed by a VoIP telephone company, for example. Further, the plurality of client telephony bridging devices 110-118 service routing of telephone calls between a first PSTN or cellular device and another PSTN or cellular device via the Internet to reduce or minimize PSTN tolls. These operations will be described further with reference to FIG. 2.

Server processing circuitry resides within server 136, 138, and/or is distributed among the plurality of client telephony bridging devices 110-118 according to embodiments of the present invention. The server processing circuitry enables telephony bridging setup, telephony bridging, subscriber tracking, and billing operations according to the present invention. The server processing circuitry is operable to assist and enable the bridging of calls and to manage subscribers supported by the client telephony bridging devices 110-118. The server processing circuitry may be co-located with one or more of the client telephony bridging devices 110-118 and/or may be distributed among the plurality of client telephony bridging devices 110-118.

In one of its operations, the server processing circuitry receives a voice call setup request from a calling voice terminal via the Internet 106 that identifies a subscriber. The subscriber may correspond to a particular VoIP terminal, e.g., VoIP telephone 120, or may simply be subscriber to the system. The server processing circuitry obtains access rules for the subscriber and, based upon the access rules for the subscriber and based upon access rules for the plurality of client telephony bridging devices 110-118, selects a servicing telephony bridging device from the plurality of client telephony bridging devices 110-118. For example, if a subscriber using VoIP terminal 120 desires to connect a call to PSTN telephone 132, the voice call setup request would identify PSTN telephone 132 or a subscriber associated therewith. The server processing circuitry considers the characteristics of the requesting subscriber and the bridging availability of each of the plurality of client telephony bridging devices 110-118. Based upon these considerations, the server processing circuitry selects a servicing client telephony bridging device, e.g., client telephony bridging device 114, to service the telephone call. The servicing client telephony bridging device 114 then operates to bridge the call that is incoming from VoIP telephone 120 between the Internet 106 and the wired PSTN 102 and to complete the call to PSTN telephone 132.

In further operations according to the present invention, the server processing circuitry monitors usage of the client telephony bridging device 114 by the serviced subscriber for record keeping purposes. In keeping records, the server processing circuitry may track bridging usage of the client telephony bridging device 114 by the subscriber. For example, each of a plurality of subscribers of the system of the present invention may each have associated therewith one or more respective client telephony bridging devices that they have agreed to allow use of by other subscribers. In exchange for allowing use of its client telephony bridging device, a subscriber is allowed to use client telephony bridging devices of other subscribers. Such shared usage may be billed on a usage basis, billed as a monthly service fee, or performed according to a bartering arrangement. Subscribers that do have associated therewith a client telephony bridging device may simply pay a monthly fee and/or a usage fee to use the client telephony bridging devices of other subscribers.

As will be further described with respect to FIG. 2, each of the plurality of client telephony bridging devices 110-118 accesses the wired PSTN 102, the cellular network(s) 104, or another telephony network at a particular location. By the server processing circuitry selecting a particular client telephony bridging device of the plurality of client telephony bridging devices 10-118 for servicing each particular bridged call, PSTN charges may be reduced or eliminated.

Each of the subscribers of the system of the present invention is subject to subscriber-based access rules. The subscriber-based access rules govern access of the subscribers to the system to the plurality of client telephony bridging devices 110-118. Each of the client telephony bridging devices 110-118 has associated therewith device-based access rules that govern respective access to the devices. Generally, the server processing circuitry governs the subscriber-based access rules while the server processing circuitry and/or respective client telephony bridging devices govern device-based access rules.

Each of the client telephony bridging devices 110-118, in addition to supporting telephony bridging, also supports a local subscriber. According to the present invention, local subscriber use of the client telephony bridging device is coordinated with the telephony bridging operations of the client telephony bridging device. For example, device-based and/or subscriber-based access rules are in effect for a local subscriber and his/her client telephony bridging device 112. According to these access rules, the local subscriber agrees to allow usage of his client telephony bridging device 112 for the bridging of calls of other subscribers. With these access rules in place and while the client telephony bridging device 112 is bridging a voice call for a non-local subscriber, the client telephony bridging device 112 receives a use request by the local subscriber. The access rules, however, provide that in exchange for the use of other client telephony bridging devices, the local subscriber has given up the right to access his client telephony bridging device 112 while it is in use bridging a call. Thus, when the client telephony bridging device 112 receives the use request by the local subscriber, instead of granting access immediately, the client telephony bridging device 112 may send a report to the server processing circuitry that a local subscriber use request has been received. The server processing circuitry then interacts with the client telephony bridging device 112 to grant delayed access or to deny access to the local subscriber.

In another operation, based upon the access rules, the server processing circuitry may initiate handover of the bridged call to a different client telephony bridging device and then allow the local subscriber access to the local client telephony bridging device 112. In still another operation, the server processing circuitry may direct the client telephony bridging device 112 to provide an indication to the non-local subscriber (for which the voice call bridging service is being provided) that the voice call bridging service will be terminated. After such notice is given, the server processing circuitry would direct the client telephony bridging device 112 to terminate the bridged call and then to provide access to the local subscriber corresponding to the client telephony bridging device 112. In still another operation, the client telephony bridging device 112, based upon instructions from the server processing circuitry, may simply deny access to the local subscriber. Of course, other operations may be supported according to the present invention in granting various levels of access to the client telephony bridging device 112.

The client telephony bridging device 112 may be an emergency access button that, upon activation, grants immediate access to the local subscriber. For example, when a local subscriber would require access to a 911 link, the client telephony bridging device 110 would immediately provide access to the local subscriber. When the local subscriber required immediate access to the client telephony bridging device 110 in a non-emergency operation, a billing penalty or barter exchange system penalty may be applied to the local subscriber based his/her immediate non-emergency access.

The client telephony bridging device 110 may include a button that places the client telephony bridging device 110 in a shared mode upon activation. When in the shared mode, the client telephony bridging device 110 would be available for non-local subscriber access for call bridging operations. When not in the shared mode, the client telephony bridging device 110 would not be accessible for bridging of non-local subscribers. These operations may be recognized in the local-user's subscriber or bartering agreement.

In another operation, the local subscriber may have a first level access to the client telephony bridging device 112 while a non-local subscriber would have a second level of access to the client telephony bridging device 112. Such access may vary during time of day, day of week, week of month, and month of year for each of the plurality of client telephony bridging devices 110-118. For example, when a local subscriber of a bridging device, e.g., 110, travels, the local subscriber may press a button or enter a code into the client telephony bridging device 110 to indicate that he will be traveling. Based upon this input, the server processing circuitry understands that local use of the client telephony bridging device 110 is not required for a period and more liberally allows the client telephony bridging device 110 to be used for call bridging by non-local subscribers.

In another operation according to the present invention, the access rules may change based upon a particular subscriber's usage of one or more non-local client telephony bridging devices. For example, in a barter use system or another usage based system, when a subscriber's use of non-local client telephony bridging devices exceeds a threshold over a given period, the subscriber may be precluded from further use during a relevant period, be additionally billed for the heavy use, or be provided reduced access to the system. At this point, the subscriber could opt to pay additional fees for additional use or simply accept limited accessibility to the client telephony bridging devices of other subscribers.

According to another embodiment of the present invention, the distributed server processing circuitry is contained in one or more of the client telephony bridging devices 110-118. According to this embodiment, one or more of the client telephony bridging devices and its corresponding distributed server processing circuitry stores PSTN access point information regarding at least some of the plurality of client telephony bridging devices 110-118. This PSTN access point information may include the area code and prefix of the point at which the corresponding client telephony bridging device accesses the PSTN. For example, each of the client telephony bridging devices 110-118 would access PSTN 102 or a cellular network 104 at a differing location. Thus, it would be advantageous for a local client telephony bridging device to terminate a VoIP to PSTN bridged call at a PSTN location that will avoid toll charges. Such VoIP to PSTN bridged call may be between a VoIP terminal 122 and a PSTN terminal 134, between PSTN terminals, between a cellular terminal 128 and a VoIP terminal 122, between cellular terminals, or between any two terminals for which call bridging would be advantageous.

With this embodiment, as an example, a first one of the plurality of client telephony bridging devices, e.g., 112 receives a call bridging setup request from a calling VoIP terminal 122. The call bridging request includes a PSTN number of a destination PSTN terminal 134. In response to this call bridging setup request, the client telephony bridging device 112 retrieves PSTN access point information regarding at least some of the plurality of client telephony bridging devices 110-118. Based upon the PSTN access point information and the destination PSTN number corresponding to PSTN terminal 134, the first client telephony bridging device 112 selects a second one of the plurality of client telephony bridging devices 114 for call bridging. Then, the first client telephony bridging device 112 interacts with the second client telephony bridging device 114 to enable the second client telephony bridging device 114 to bridge the call between the Internet (packet data network 106) and the PSTN 102 to support termination of the call to the destination PSTN terminal 134.

Because the server processing circuitry is distributed among the client telephony bridging devices 110-118, any of these devices 110-118 may service an incoming bridging request from a VoIP terminal. The reader should appreciate that any of the functions described herein with reference to a particular client telephony bridging device may be performed by a single client telephony bridging device or by multiple client telephony bridging devices depending upon the particular embodiment.

FIG. 2 is a system diagram illustrating an infrastructure constructed and operating according to another embodiment of the present invention. The infrastructure includes a plurality of client telephony bridging devices 224, 226, 227, and 220, the Internet 202, domestic packet data network(s) 204, foreign packet data network(s) 206, a domestic PSTN 208, a domestic cellular network 209, a foreign PSTN 220, and a foreign cellular network 221. With the embodiment of FIG. 2, domestic PSTN 208, domestic packet data network(s) 204, and domestic cellular network 209 reside within one geographic locale, e.g., the United States, a portion of the United States, or a portion of a state of the United States. Likewise, the foreign packet data network(s) 206, foreign PSTN 220, and foreign cellular network 221 reside within a differing locale. Such differing locale may be a European country, an Asian country, a South American country, or another locale that differs from the domestic locale. The Internet 202 is an international network that communicatively couples between domestic packet data network(s) 204 and foreign packet data network(s) 206. Coupled to the Internet 202 are one or more WLANs 223 and/or other wireless packet data networks.

Domestic cellular network 209 communicatively couples to domestic PSTN 208 and services cellular handset 234. In another structure according to the present invention, the cellular network 209 couples directly to the domestic packet data network(s) and/or the Internet 202. Domestic PSTN 208 services PSTN telephone 232 and couples to client telephony bridging devices 224 and 226. Domestic packet data network 204 services VoIP telephones 238 and 240 and couples to client telephony bridging devices 224 and 226. Foreign PSTN 220 services PSTN telephone 246 and couples to client telephony bridging devices 228 and 230. The foreign cellular network 221 services cellular telephone 248 and communicatively couples to the foreign PSTN 220. In an alternate construct, the foreign PSTN 220 couples directly to the foreign packet data network(s) 206 and/or to the Internet 202. The foreign packet data network 206 services VoIP telephone 244 and couples to both client telephony bridging device 228 and to client telephony bridging device 230. WLAN(s) 223 service VoIP terminal 242.

Interexchange connection 222 intercouples domestic PSTN 208 with foreign PSTN 220 and routes PSTN telephone calls between the domestic PSTN 208 and the foreign PSTN 220 according to conventional operations. With a conventional PSTN telephone operation, PSTN telephone 232 desires to establish a call with PSTN telephone 246. In doing so, the user of PSTN telephone 232 enters an unique PSTN telephone number corresponding to PSTN telephone 246. Domestic PSTN 208, interexchange connection 222, and foreign PSTN 220, in combination, service the PSTN call between the PSTN telephone 232 and 246. With this conventional operation, both the domestic PSTN 208 and the foreign PSTN 220 charge one or more accounts corresponding to the PSTN telephones 232 and 246 for establishing and servicing the telephone call. Such charges may be excessive and preclude communication between domestic and foreign users.

According to the infrastructure of the present invention, the plurality of client telephony bridging devices 224, 226, 228, and 230 service voice and multimedia calls in a manner that differs from prior systems. In one example of operation of the system of the present invention, a user of PSTN telephone 232 desires to establish a call to PSTN telephone 246. In performing this operation, user of PSTN telephone 232 communicatively couples with client telephony bridging device 224, for example, via the domestic PSTN 208. The user of PSTN telephone 232 then interacts with the client telephony bridging device 224 via touch pad operations, a voice recognition system, voice mail vectoring operations, or other means to indicate that it desires to establish a call with PSTN telephone 246. Client telephony bridging device 224 then either interacts with server 254 or interacts directly with client telephony bridging device 228 or 230 via the domestic packet data network(s) 204, the Internet 202, and the foreign packet data network(s), which couples to foreign PSTN 220.

Client telephony bridging device 224, in interacting with client telephony bridging device 230, establishes permission for use of client telephony bridging device 230 and provides sufficient information to enable client telephony bridging device 230 to establish a PSTN telephone call with PSTN telephone 246. With the connection setup, client telephony bridging device 230 establishes a call path to PSTN terminal 246. Client telephony bridging devices 224 and 230 establish a complete routing path between PSTN telephone 232 and PSTN telephone 246 that includes the domestic PSTN 208, client telephony bridging device 224, domestic PDN 204, the Internet 202, foreign packet data network 206, client telephony bridging device 230, and foreign PSTN 220 to service the call between a user of PSTN telephone 232 and a user of PSTN telephone 246. Because the telephone call is established and serviced other than via the interexchange connection 220, significant PSTN toll charges are reduced or alleviated to service the call.

In a somewhat similar operation, a user of VoIP telephone 244 desires to establish a call with cellular telephone 234. With conventional operations, use of the interexchange connection 222 would be required. According to the present invention, this call is serviced via VoIP telephone 244, foreign packet data network(s) 206, the Internet 202, domestic packet data network(s) 204, client telephony bridging device 226, domestic PSTN 208, cellular network 209, and cellular telephone 234. The call is setup initially via interaction between VoIP telephone 244 and client telephony bridging device 226, which completes the connection to cellular telephone 234. Then, during the call, client telephony bridging device 226 bridges the call between domestic packet data network(s) 204 and domestic PSTN 208.

Likewise, VoIP telephone 238 or 240 may establish a call with cellular telephone 248 via domestic packet data network(s) 204, Internet 202, foreign packet data network(s) 206, one of client telephony bridging devices 228 and 230, foreign PSTN 220, and foreign cellular network 221. Routing the call in this fashion reduces significantly in the cost of PSTN toll charges. These operations could also be supported among any terminal pair illustrated in the system of FIG. 2.

According to another operation of the present invention, a client telephony bridging device 224 is bridging a call for PSTN terminal 246 and PSTN terminal 232 to reduce their PSTN toll charges. The communication path for such servicing may include foreign PSTN 220, client telephony bridging device 230, foreign packet data network(s) 206, the Internet 202, domestic packet data network(s) 204, client telephony bridging device 224, and the domestic PSTN 208. Then, a local subscriber of the client telephony bridging device 224, using user interface 236, desires to use the client telephony bridging device 224 to place a call. At this time, action must be taken with regard to the local subscriber. In a first operation, client telephony bridging device 224 simply ceases bridging of the call between PSTN terminal 246 and PSTN terminal 232. In a second operation, the client telephony bridging device 224 gives notice of impending termination of the bridged call and then terminates bridging. In a third operation, the client telephony bridging device 224 decides that it will deny access to the local subscriber. In making this determination, the client telephony bridging device 224 may access server 254 to obtain access rules relating to the subscriber and/or the client telephony bridging device 224.

Prior to terminating a bridged call, the client telephony bridging device 224 may establish another path for the bridged call for servicing via another client telephony bridging device, e.g., client telephony bridging device 226. The newly established communication path including client telephony bridging device 226 would then service the call between PSTN terminal 246 and PSTN terminal 232. In taking over the bridging operations, the client telephony bridging devices 224 and 226 may first establish a three-way call with PSTN terminal 232 via the domestic PSTN 209. Then, client telephony bridging device 224 may simply drop the call. The client telephony bridging device must also receive VoIP packets via the domestic packet data network(s) 204 that support the bridged call. Receipt of VoIP packets may simply be accomplished by redirecting the VoIP packets transmitted by client telephony bridging device 230. While transitioning from client telephony bridging device 224 to client telephony bridging device, VoIP packets may be multicast from client telephony bridging device 230 to both client telephony bridging device 224 and client telephony bridging device 226.

According to the present invention, owners/local users/local subscribers of the client telephony bridging devices 224, 226, 228, and 230 share their devices with subscribers or local owners of other client telephony bridging devices. Such sharing may be under a bartering system or a subscriber agreement. With this shared system of the present invention, the system need not have VoIP gateways deployed at local PSTN connection points. Such is the case because the client telephony bridging devices 224-230 serve the purpose of the gateways without requiring particular deployments.

Thus, for example, if a individual purchases a device such as a set-top box 228 that supports client telephony bridging operations, the user may simply use the set-top box 228 to service a high definition television monitor 252 and remote control 250 to watch received programming. However, the user may determine that it would be advantageous to become a subscriber to the system of the present invention to gain the benefits of access to other client telephony bridging devices. In such case, the owner of set-top box 228 (client telephony bridging device) would setup the device as a client telephony bridging device. Then, based upon a subscription level of the user, or user preferences, the set-top box 228 (client telephony bridging device) would service call bridging for non-local subscribers. For example, the local subscriber corresponding to client telephony bridging device 228, having given access to non-local subscribers to client telephony bridging device 228, in exchange gains access to non-local client telephony bridging devices 226, 228, and 230. The local subscriber corresponding to client telephony bridging device 228 could access the foreign PSTN 220 without an access charge or PSTN toll fees in some cases.

The manner in which the plurality of subscribers corresponding to the plurality of client telephony bridging devices 224-230 exchange services may be in a bartering system. In such case, each of the client telephony bridging devices either alone or in communication with server 254 monitors its usage by non-local subscribers. Based upon this usage level, the local subscriber would have access to non-local client telephony bridging devices for his or her own bridging operations. For example, a caller residing in Prague, Czech Republic would like to place a call to California. The caller in Prague has an Internet phone that is attached wirelessly to the Internet 202, e.g., via wireless LAN 223 and VoIP terminal 242. Upon attachment to the wireless LAN 223, the VoIP terminal 242 accesses server 254 which responds with one or serveral recently registered client telephony bridging devices 224 and 226 that are able to offer gateway service in the desired (949) 321 central office area. In one operation the server 254 provides the IP addresses of the available client telephony bridging devices 224 and 226 and also their associated domestic PSTN 208 access point information, e.g., (949) 321. Then, the VoIP terminal 242, via wireless LAN 223, Internet 202 and domestic PDN 204 interacts with either client telephony bridging device 224 or 226 to access PSTN telephone 232 or cellular terminal 234. If one of the client telephony bridging devices 224 or 226 can service the call, then the caller at VoIP terminal 242 establishes the telephone call to PSTN telephone 232 or cellular terminal 234 with little or no PSTN toll charges. During dependency of the call, the client telephony bridging device, e.g., 226, acting as a gateway for the call identifies or tracks the usage by VoIP telephone 242. Later, the usage will be used in determining what access or perhaps what charge to be incurred to the subscriber respective to VoIP telephone 242.

The system of the present invention could use an annual subscription basis, a usage basis, a combination of usage and annual fee, or simply an annual fee plus a barter type arrangement. When a bartering system is established, each local subscriber may be required to allow a certain number of minutes of access to his/her respective client telephony bridging device or devices. In return, the subscriber may receive a like number of minutes of bridged telephone calls. However, many variations could exist in this bartering arrangement, examples being if a subscriber pays a larger fee, he could use other non-local client telephony bridging devices more than he allows usage of his local client telephony bridging device. According to another aspect to the present invention, a client telephony bridging device such as client telephony bridging device 224 may support 3-way bridging. With such 3-way bridging, the client telephony bridging device 236 could establish a call conference between one or more VoIP telephones, e.g., 238 and 240, and one or more PSTN telephones 232 and 234, for example. The client telephony bridging device 224 support such operations because they couple both to the domestic PSTN 208 and domestic packet data network and include circuitry therein for performing such bridging and conferencing activities.

Server processing circuitry of the present invention may be distributed among the plurality of client telephony bridging devices 224, 226, 228, and 230. The server processing circuitry of any of these devices may operate to setup a VoIP to PSTN call, PSTN to VoIP call, or a PSTN to PSTN call. Further PSTN access point information, subscriber tracking information, and other information may be stored locally at one, a plurality of, or all of the client telephony bridging devices 224, 226, 228, and 230. As was previously described with reference to FIG. 1, the server processing circuitry functionality of the infrastructure resident in one, more than one, or all of the plurality of client telephony bridging devices 224-230 operates to manage the system. Any of the operations previously described or described further herein may be performed jointly by the server processing circuitry of multiple of the plurality of client telephony bridging devices 224-230.

In one example of a PSTN to PSTN call termination, a first one of the plurality of client telephony bridging devices 224 receives a call bridging setup request from a calling PSTN terminal 232. The call bridging setup request includes a calling PSTN number and a destination PSTN number of a destination PSTN terminal 246. The first one of the plurality of client telephony bridging devices 224 retrieves PSTN access point information regarding at least some of the plurality of client telephony bridging devices 224-230. This PSTN access point information may be distributed among the plurality of client telephony bridging devices 224-230. Alternately, one of the client telephony bridging devices may serve as a master database for all PSTN access point information. Still further, there may be a primary repository for the PSTN access point information and multiple backup locations for the PSTN access point information. In seeking PSTN access point information, the first one of the plurality of client telephony bridging devices 224 may, for example, access client telephony bridging device 226 first. Then, if it does not obtain the information desired, it may access differing client telephony bridging devices 228 and 230 seeking the desired PSTN access point information. Because the first one of the plurality of client telephony bridging devices 224 communicates with the other client telephony bridging devices 226, 228 and 230 via the Internet 202, the cost of such communications is minimal.

More particularly, in one embodiment, the client telephony bridging devices are logically arranged in a spanning tree structure. At least one of the client telephony bridging devices is designated as a root node and other client telephony devices are directly and indirectly (via other client telephony bridging devices) attached thereto. Through this spanning tree arrangement, which adjusts over time as client telephony bridging devices come online and go offline, an available, local client telephony bridging device of a large plurality of client telephony bridging devices can be identified to support a VoIP to PSTN low cost call.

For example, a user of a VoIP phone in Texas desires to place a VoIP to PSTN call to a PSTN telephone of a friend in Chicago. The Texas user needs to gain access to a VoIP to PSTN bridge that not only routes VoIP voice packets to PSTN voice signals and vice versa, but also manages call setup, call termination and other telephony function bridging. Although any VoIP to PSTN bridge would be sufficient, a VoIP to PSTN bridge located in Chicago (hereafter a “Chicago bridge”) might be most desirable to avoid long distance charges associated with the PSTN link between the VoIP to PSTN bridge and the friend's PSTN phone.

To locate a Chicago bridge (i.e., a client telephony bridging device in Chicago), the user's VoIP phone first looks in its local phonebook database to attempt to find a known Chicago bridge—perhaps one of a family member or another friend. If no known Chicago bridge is found, the VoIP phone sends an inquiry to either a supporting server device (in a centralized server embodiment) or a server component of one of the client telephony bridging devices (in a distributed server embodiment). The inquiry identifies the PSTN telephone number of the friend's PSTN phone. In response to the inquiry and based on the PSTN telephone number, the server or client telephony bridging device accesses a local mapping database using the PSTN telephone number to identify an IP address or address handle (hereinafter “address information”) associated with one of perhaps a large plurality of available Chicago bridges. Thereafter, through the identified Chicago bridge, the VoIP phone interacts to set up and maintain the call with the friend's PSTN phone.

With the distributed server infrastructure, if the server component of the client telephony bridging device is unable to find an available Chicago bridge or a pathway to such bridge in its own mapping database, the client telephony bridging device routes the inquiry upstream toward the root node and to another of the client telephony bridging devices for servicing. This upstream routing process continues until the Chicago bridge is located, a downstream pathway thereto is found, or the root node is reached. Upon reaching the root node, if no index to an available Chicago bridge or a downstream pathway thereto is found, then no Chicago bridge is currently available. If any client telephony bridging device processing the inquiry lists a downstream pathway to an available Chicago bridge, the inquiry is forwarded downstream to the next node (another client telephony bridging device) in the pathway for processing. This downstream process is repeated until the available Chicago bridge is found. Of course, other schemes than spanning tree may be used for distributing the mapping database content amongst the plurality of client telephony bridging devices. Also, instead of distributing the mapping database or servicing the full mapping database from the supporting server device, the full mapping database can be mirrored on a plurality or all of the client telephony bridging devices.

The mapping database, whether or not distributed, provides address information of an available client telephony bridging device in response to an inquiry that identifies a desired PSTN telephone number. Each of the client telephony bridging devices register with the central or distributed mapping database by providing their address, status, capabilities, and billing information, for example. As a client telephony bridging device becomes engaged or status otherwise changes, the client telephony bridging device records the status change with the mapping database. Mapping involves finding an available, client telephony bridging device near (from a PSTN routing standpoint) the desired destination PSTN phone. For example, if the destination PSTN phone number consists of “1-949-328-1010”, the mapping database might return an IP address or handle for a client telephony bridging device with a phone number “1-949-328-3978” by attempting to match at least the first seven (7) digits. Using the IP handle, the tracking database may be used to return the actual IP address thereof. With the IP address of the local client telephony bridging device, a VoIP to PSTN call to the destination can be established.

In an alternate configuration, based upon its access, the first one of the plurality of client telephony bridging devices 224 retrieves PSTN access point information regarding at least some of the plurality of client telephony bridging devices 226, 228, and 230. The first one of the plurality of client telephony bridging devices 224 then selects a second one of the plurality of client telephony bridging devices 230 based upon the PSTN access point information and the destination PSTN number of the destination PSTN terminal 246.

In a first operation in this regard, the first one of the plurality of client telephony bridging devices 224 is operable to bridge a call between the PSTN 208 and the Internet 204 to service the calling PSTN terminal 232. In an alternate operation at this point, the first one of the plurality of client telephony bridging devices 224 selects a third one of a plurality of client telephony bridging devices 226 for bridging the call between the PSTN 208 and the Internet 204 to service the calling PSTN terminal 232. The first one of the plurality of client telephony bridging devices 224 interacts with the second one of the plurality of client telephony bridging devices 230 to bridge the call between the Internet 202 and the PSTN 222 and to support termination of the call to the destination PSTN terminal 246. In this operation, the first one of the plurality of client telephony bridging devices 224 may monitor the usage by the call and use it to bill subscribers, enter usage information in a barter exchange system, or otherwise oversee operation of the system.

The client telephony bridging device 224 may implement encryption to protect the identity of another servicing client telephony bridging device. Further, the client telephony bridging device 224 may enact encryption in order to avoid eavesdropping in ongoing communications.

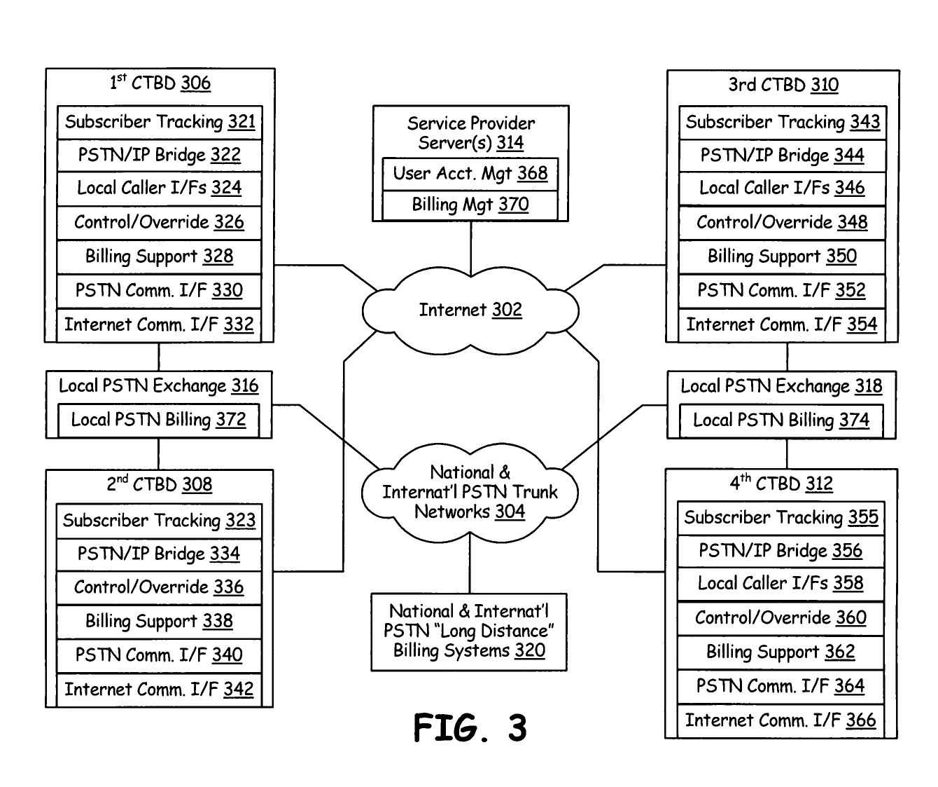

FIG. 3 is a block diagram illustrating a plurality of client telephony bridging devices and their interconnection to various telephony infrastructure components constructed and operating according to an embodiment of the present invention. Shown are client telephony bridging devices 306, 308, 310, and 312. The structure of the client telephony bridging devices 306-312 illustrated in FIG. 3 includes functional components that are employed with the operations of the present invention. These functional components may be embodied in hardware components, software components, or a combination of hardware components and software components. The client telephony bridging devices may include additional components that are not illustrated in FIG. 3.

As shown, each of the plurality of client telephony bridging devices 306-312 couples to the Internet 302. Further, first client telephony bridging device 306 and second client telephony bridging device 308 couple to local PSTN exchange 316. Third client telephony bridging device 310 and fourth client telephony bridging device 312 couple to local PSTN exchange 318. Each of the local PSTN exchanges 316 and 318 communicatively couple to national and international PSTN trunk networks 304.

Coupled to the Internet 302 also is one or more service provider servers 314 that may operate according to the present invention in conjunction with the client telephony bridging devices 306-312. Further, coupled to the national and international PSTN trunk networks 304 are one or more national and international PSTN long distance billing systems 320.

Referring now to the first client telephony bridging device 306, the client telephony bridging device 306 includes a PSTN communication interface 330 that communicatively couples the client telephony bridging device 306 to the local PSTN exchange 316. Further, the client telephony bridging device 306 includes Internet communication interface 332 that communicatively couples the client telephony bridging device 306 to the Internet 302. The first client telephony bridging device 306 includes one or more local caller interfaces 324 that service one or more local users of the client telephony bridging device 306. The local caller interface(s) 324 may service wireless handsets, wired handsets, headsets, or other devices that allow a local subscriber to place and receive calls via the client telephony bridging device 306.

According to the present invention, the client telephony bridging device 306 includes subscriber tracking functionality 321 and PSTN to VoIP bridging functionality 322. As was previously described with reference to FIGS. 1 and 2, the client telephony bridging device 306 is operable to bridge calls between the PSTN 316 and the Internet 302. In such case, with the particular structure of FIG. 3, client telephony bridging device 306 is operable to enact the PSTN/IP bridge functionality 322 to bridge calls between the national and international PSTN trunk networks 302 and the Internet 302 via local PSTN exchange 316 and PSTN communication interface 330 and Internet communication interface 332. The subscriber tracking functionality 321 may operate in cooperation with subscriber tracking functionality of other of the client telephony bridging devices 308, 310, and 312 such that this functionality is distributed across the client telephony bridging devices 306-312. This functionality may be performed by, and is described herein as, server processing circuitry.

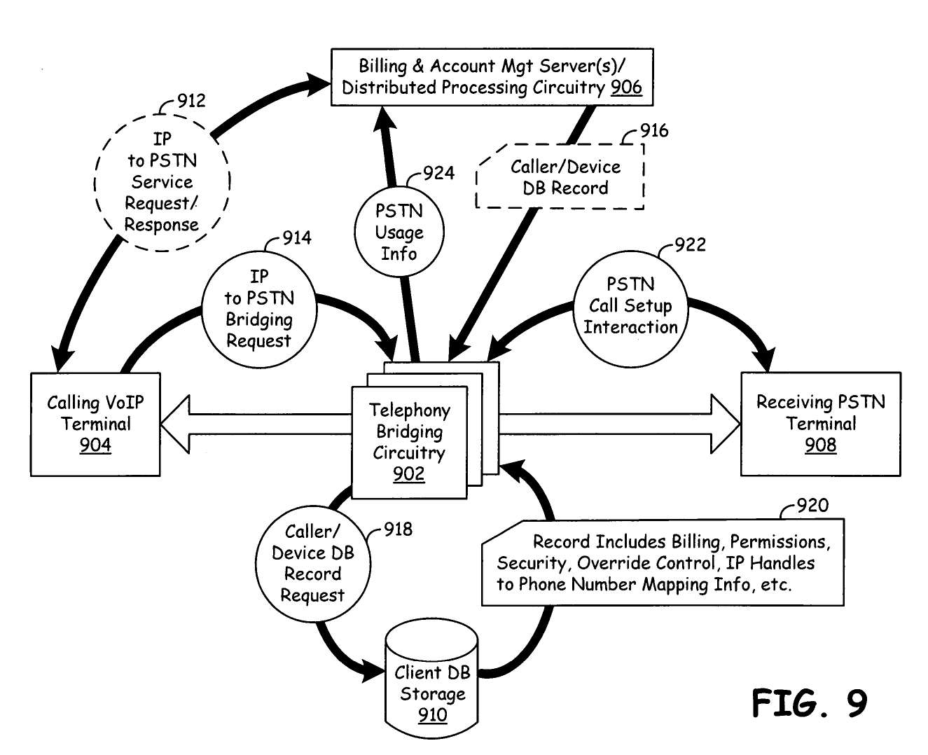

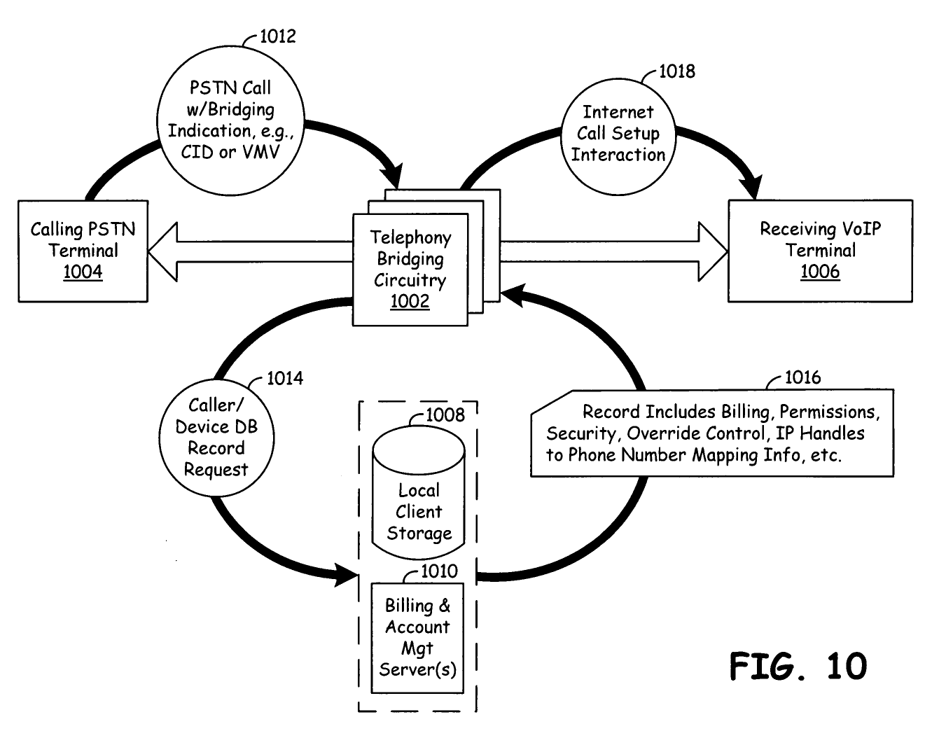

With the operations of the present invention, the client telephony bridging device 306 includes control and override functionality 326. Such control and override functionality 326 allows a local subscriber/user of the device 306 to enable or disable bridging functionality, enable or disable local caller use, and to provide other control and override functionality. Billing support functionality 328 of the client telephony bridging device 306 supports interactions between the client telephony bridging device and billing management software running on service provider servers 314 and/or with the national and international PSTN long distance billing systems 320. The operations supported by the billing support 328 will be described further with reference to FIGS. 9 and 10.

The second, third, and fourth client telephony bridging devices 308, 310, and 312, include similar functional components. For example, the second client telephony bridging device 308 includes subscriber tracking functionality 323, PSTN/IP bridging functionality 334, control/override functionality 336, billing support functionality 338, a PSTN communication interface 340, and an Internet communication interface 342. Note that client telephony bridging device 308 does not include a local call interface 324. Such may be the case with a set-top box, for example, that does not serve primarily as a voice of multimedia communications device for a local subscriber.

Likewise, the third client telephony bridging device 310 includes subscriber tracking functionality 343, PSTN/IP bridging functionality 344, local call interface(s) 346, control/override functionality 348, billing support functionality 350, a PSTN communication interface 352, and an Internet communication interface 354. The fourth client telephony bridging device 312 includes subscriber tracking functionality 355, PSTN/IP bridging functionality 356, one or more local caller interfaces 358, control/override functionality 360, billing support functionality 362, a PSTN communication interface 364, and an Internet communication interface 366.

According to some aspects of the present invention, the client telephony bridging devices 306-312 are employed in order to eliminate or minimize PSTN toll charges for serviced subscribers. The system of the present invention may have its own subscriber usage and/or billing functions. As was previously described, a bartering system or a subscription service may be employed for users of the client telephony bridging devices 306-312. In such case, the billing support functionality of the client telephony bridging devices 306-312 may interact with billing management functionality 370 of the service provider server(s) 314. Further, in determining how subscribers may access any of the client telephony bridging devices 306-312, the user account management functionality 326 of the service provider server 314 is enacted in conjunction with control functionality of the client telephony bridging devices.

Each of the local PSTN exchanges 316 and 318 includes local PSTN billing functionality 372 and 374, respectively. This local PSTN billing functionality 372 and 374 causes an accessing client telephony bridging device to pay PSTN access and use fees in some cases. According to the present invention, some of these usage fees or access fees may be accounted for by the billing management functionality 370 of the service provider server 314 to allocate such costs to particular subscribers of the system of the present invention.

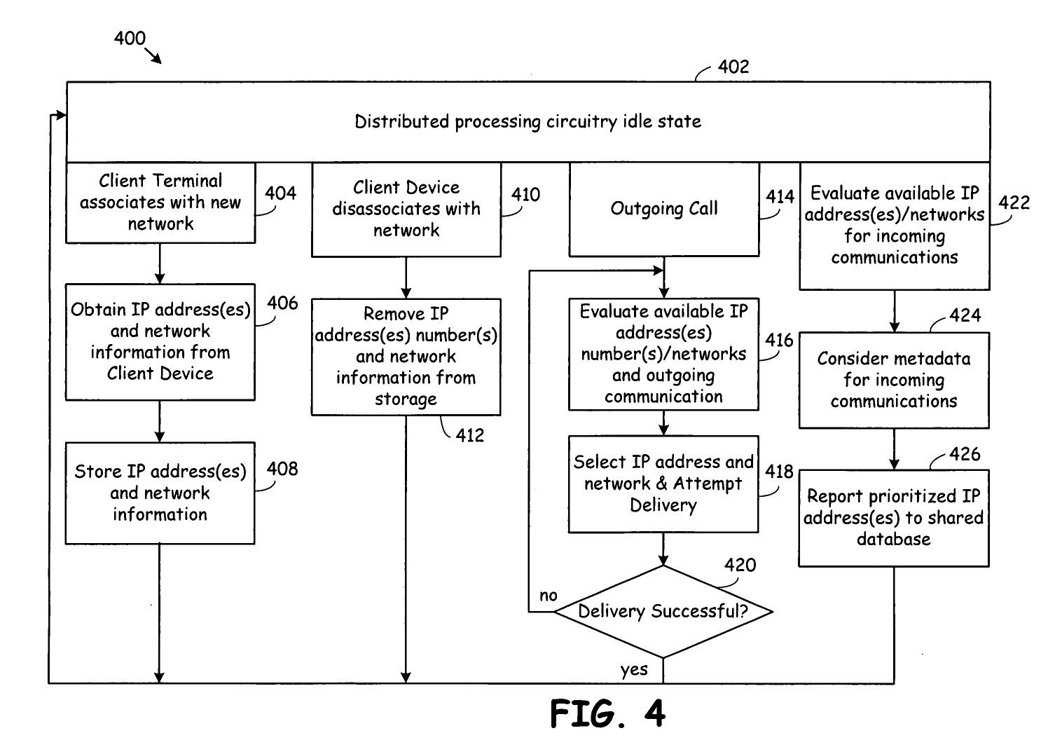

FIG. 4 is a flow chart illustrating the operation of distributed processing circuitry according to an embodiment of the present invention. The operations of FIG. 4 are performed by one or more of a plurality of client telephony bridging devices. These operations may be performed in cooperation with a central server in other embodiments. With the operations of FIG. 4, distributed server processing circuitry tracks IP addresses of subscriber terminals, e.g., VoIP terminals illustrated in FIGS. 1 and 2. Operation 400 of FIG. 4 commences with the distributed processing circuitry operating in an idle state in step 402. From step 402, a tracked subscriber terminal may associate with a new network in step 404. In the association, the subscriber terminal will receive an IP address and network information from a servicing access point or network. In response thereto, the distributed processing circuitry obtains such IP addresses and network information from the client device in step 406. The distributed processing circuitry then stores the IP addresses and network information received for the particular IP pathway in step 408. From step 408, operation returns to step 402. In another operation, the client device disassociates with a particular network in step 410. In such case, the distributed processing circuitry removes the IP address or addresses associated with the network and the network information from storage in step 412. From step 412, operation returns to step 402.

In another operation, the subscriber terminal desires to establish communications in step 414, (e.g., to a destination subscriber terminal). In response thereto, the distributed processing circuitry evaluates the type of communication desired and the available IP addresses and networks with which the subscriber terminal is associated (in step 416). Based upon this evaluation, the distributed processing circuitry selects an IP address and a network for the packet data communication transmission and attempts delivery via the selected IP pathway in step 418. If delivery is not successful (as determined at step 420), operation returns to step 416. However, if the delivery is successful as determined at step 420, operation returns to step 402.

To support incoming communications, the client application is operable to evaluate the available IP addresses and networks in step 422. In step 424, user preferences will be considered for the prioritization of IP addresses for incoming communications. In step 426, the prioritized IP addresses and metadata associated with communication types and the various capabilities of the terminal network and communications are reported to the shared database such that the client application manages not only outgoing communications but incoming communications as well

With the operations 400 of FIG. 4, the distributed processing circuitry may consider the data type for incoming and outgoing communications, a latency of each IP pathway, the cost of each IP pathway, and other relevant IP pathway considerations. For example, for some packet data servicing, the distributed processing circuitry may select a low cost IP, high latency IP pathway for some type of communication, such as low priority text only, while selecting a low latency, high cost IP pathway for other types of packet data, such as voice or audio/visual communications. The distributed processing circuitry may also select a particular IP path for packet data transmission based upon the network operational parameters of the available networks associated with the subscriber terminal. For example, the distributed processing circuitry may evaluate the traffic loading of the various available IP pathways prior to selecting an IP pathway for a particular packet data communication.

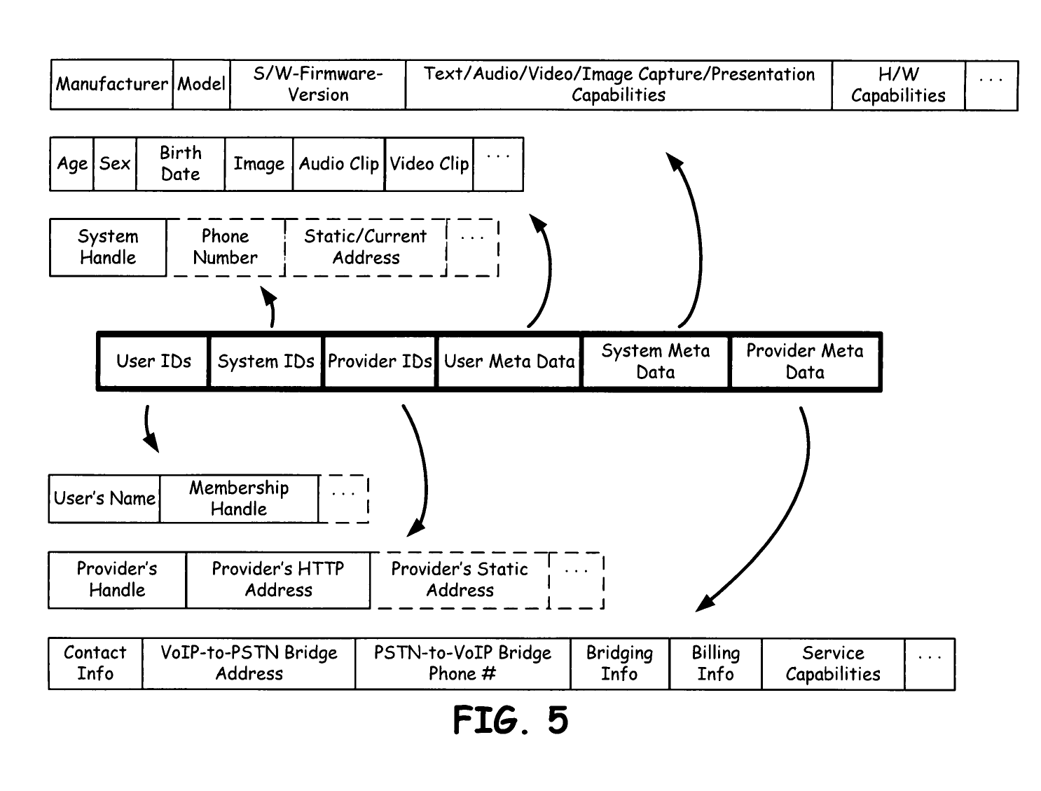

FIG. 5 depicts various cross reference identifiers that may include one or more user identifiers, terminal identifiers and service provider identifiers. These user identifiers may be stored and managed by the distributed processing circuitry of the plurality of client telephony bridging devices 110-118 of FIG. 1 and/or 224-230 of FIG. 2. For example, user identifiers may include user name, member handle, or other like information. System identifiers may include a system handle, phone number, ESN, stacker card address, or other like information. A provider I.D. may include a provider handle, a network address, a static address, or other like information. In addition to the user system and provider identifiers, various meta data may be associated with these identifiers. For example, personal information such as the age, sex, birth date, image, audio clip, video clip, authorization information, or other like information may be associated with a user. The terminal identifier may contain information such as manufacturer, model number, software version, multi media capabilities, hardware capabilities, or other like information. The service provider Meta data may include contact information. All this information may be stored within the distributed or centralized server infrastructure of FIG. 1 and used to facilitate and manage calls between client terminals.

User identifiers may comprise a user's name or some “handle” that uniquely identifies a user with that service provider. A service provider identifier might comprise a web address, provider name, or the provider's static IP address. The terminal identifier might be a computer name, telephone number, or serial number, for example. User information might be nearly anything related or unrelated to the overlying service (age, sex, birthdate, etc.). Terminal information might include manufacturer, model number, firmware/software/hardware version, image/video/audio capabilities, processing power, memory/storage capability, battery capability and status, operational status, available CODECs and versions, etc. As with other metadata, the terminal information might be related or not to the overlying service. Service provider information might include zero or more of service descriptions, service characteristics/limitations, service status, billing info, etc.

FIG. 6 is a block diagram illustrating a client telephony bridging device constructed according to a first embodiment of the present invention. The structure of client telephony bridging device 602 may correspond to bridging telephones 110, 226, 230, or to another client telephony bridging device of the present invention. The client telephony bridging device 602 includes processing circuitry 604 that may be a microprocessor, digital signal processor, a combination of various processors, one or more application specific integrated circuits, or another type of processing device operable to execute software instructions or to perform hard-wired operations. The processing circuitry 604 may be or include distributed processing circuitry 605 that operates according to the present invention and that was previously described with reference to prior FIGs. and as will be described with reference to subsequent FIGS. Client telephony bridging device 602 also includes memory, one or more Internet interface(s) 608, one or more PSTN interface(s) 610, user input interface(s) 612, and user output interface(s) 614.

The memory 606 is operable to store software instructions that, when executed by the processing circuitry 604, enables operation according to embodiments of the present invention. Internet interface(s) 608 communicatively couple the client telephony bridging device 602 to the Internet via wired or wireless means. For example, when the Internet interface 608 supports a wired connection, it may support a local area network connection, a DSL connection, an ISDN connection, a cable modem connection, a fiber optic connection, or another wired Internet connection supporting packet data communications. When the Internet interface 608 supports wireless connections it may support WLAN connectivity, a fixed wireless connection, a satellite cable modem interface connection, or another wireless connection such as a cellular connection. The PSTN interface(s) 610 communicatively couple the client telephony bridging device 602 to the PSTN via wired or wireless means. For example, the PSTN interface(s) 610 may include a wired connection that couples the client telephony bridging device 602 to a central office via twisted copper pair of wires. However, the PSTN interface may also support a wireless connection to a cellular network or to a central office for example. The user input interface 610 communicatively couples the client telephony bridging device 602 to user input devices such as keypads, microphones, mice, or other user input devices. User output interface(s) 614 communicatively couple the client telephony bridging device 602 to a user output device such as speakers, a monitor, or another output device.

The memory stores software instructions that, when executed by processing circuitry 604, cause the client telephony bridging device 602 to operate according to the present invention. Generally, these software instructions support functionality relating to local call processing with bridging override operations 616, distributed server processing circuitry operations 617, bridging and billing software application operations 618, PSTN to Internet call setup operations 622, Internet to PSTN call setup operations 624, PSTN usage billing support operations 626, bridging exchange processing operations 628, and security/encryption processing operations 630. Referring particularly to the local call processing with bridging override instructions 616, upon execution, the processing circuitry 604 enables the client telephony bridging device 602 to locally process calls to override bridging operations of the client telephony bridging device 602. In its normal operations, the client telephony bridging device 602 is available to bridge calls between its Internet interface(s) 608 and its PSTN interface(s) 610. However, during such bridging operations, a local subscriber may desire to access the PSTN or the Internet via user input and output interface(s) 612 and 614 that would interrupt or compromise the currently bridged call. The local call processing with bridging override functionality 616 establishes rules that allow the user to access and disrupt a currently bridged call or not depending upon the particular rules established. With the particular operation, a local subscriber may always interrupt a currently bridged call, sometimes interrupt a currently bridged call, or never interrupt a currently bridged call. The ability of a local subscriber/user to interrupt a locally bridged call may be based upon access rules that are obtained from a remote location or locally stored.

The distributed server application operations 617 enable the distributed processing circuitry 605 to implement the operations of the present invention. These operations include client telephony bridging device call setup operations, bridging device selection operations, call completion operations, call termination operations, call usage tracking operations, and subscriber tracking operations. Of course, these operations include others that have been or will be described herein.

The bridging and billing software application 618 encompasses each of remote user/device service permissions 620, the PSTN to Internet call setup operations 622, the Internet to PSTN call setup operations 624, the PSTN usage billing support operations 626, the bridging exchange processing operations 628, and the security/encryption processing operations 630. In particular, the remote user/device service permissions operations 620 allow the client telephony bridging device 602 to determine whether a remote user or a remote device may use the client telephony bridging device 602 for call bridging operations. In such case, when bridging is allowed, these operations 620 allow local, national, and international connections. In other cases, a subset of local, national, and international connections allowed are none of the above, depending upon the permissions of the remote user or remote device.

The PSTN to Internet call setup operations 622 support another PSTN device coupled to the client telephony bridging device 602 to setup an Internet call from a calling PSTN terminal. In such case, the PSTN to Internet call setup functions 622 provide audio caller ID functions, touch tone voice mail vectoring operations, or other interface operations that allow a user of a remote PSTN telephone to interact with the client telephony bridging device 602. Based upon the communications supported by the PSTN to Internet call setup functionality 622, the remote PSTN user may setup the client telephony bridging device 602 for call bridging operations.

The Internet to PSTN call setup operations 624 allow a remote VoIP terminal itself to setup call bridging by the client telephony bridging device 602. This functionality may be via a web page interface, a simpler data communication interface that causes exchanges sufficient information to enable the Internet to PSTN call setup to occur, or via another interface.

The PSTN usage and billing support operations 626 allow the client telephony bridging device 602 to determine PSTN usage by a non-local subscriber for future billing operations. The PSTN usage billing support operations 626 may interface the client telephony bridging device 602 with the billing management software of a service provider server 314. For example, if the client telephony bridging device 602 performs call bridging for a remote VoIP or PSTN terminal, the call may be bridged not only to a local PSTN telephone but to a non-local PSTN telephone wherein additional PSTN tolls are incurred. Any usage of the PSTN while servicing a bridged telephone call may result in PSTN billing to the client telephony bridging device 602. The PSTN usage billing support functionality 626 supports capturing of such PSTN usage by the client telephony bridging device 602 and subsequent interaction with a server or with another device to cause PSTN usage billing to the appropriate remote subscriber or terminal.

The bridging exchange processing functionality 628 causes the client telephony bridging device 602 to track usage of remote subscribers for call bridging operations and to track usage of a local subscriber of remote client telephony bridging devices. This functionality may operation in conjunction with a bartering system that tracks usage of various subscribers to the bartering system. In such case, these operations may ensure that usage of client telephony bridging devices by differing subscribers is equitable. If the operations are not equitable, the bridging exchange processing operations may cause notification or bills to be sent to a subscriber that uses more than an equitable amount or number of call bridging operations.

The security/encryption processing operations 630 of the client telephony bridging device are enacted to: (1) preclude a local user from listening in on bridged calls, and (2) to preclude remote users from listening on communications of a local user of the client telephony bridging device 602. Security/encryption processing operations 630 may actually mask or encrypt data communications to preclude either the processing circuitry or the user input/output interface(s) 612 or 614 from eavesdropping on communications that are bridged.

FIG. 7 is a block diagram illustrating a client telephony bridging device constructed according to a second embodiment of the present invention. The client telephony bridging device 702 that may serve as client telephony bridging device 112 or 116, for example. The client telephony bridging device 702 includes processing circuitry 704, memory 706, PSTN interface(s) 710, Internet interface(s) 708, user input interface(s) 712, and user output interface(s) 714. The Internet interface(s) 708 couple the client telephony bridging device 702 to the Internet via an ISP, or other packet data connections in a wired or wireless fashion. The PSTN interface(s) 710 couple to client telephony bridging device 702 to the PSTN via a wired and/or a wireless connection. User input interface(s) 712 may service a mouse 720, a keyboard 718, the headset 722, or another user input interface device. User output interface 714 services a monitor 716, for example. The processing circuitry 704 includes one or more microprocessors, digital signal processors, applications specific integrated circuits, field programmable gate arrays, or other circuitry capable of processing software and/or firmware instructions and operating upon data. The processing circuitry 704 may be or include distributed processing circuitry 705 that operates according to the present invention and that was previously described with reference to prior FIGs. and as will be described with reference to subsequent FIGs. Generally, the processing circuitry 704 performs personal computer operations and telephony operations.

Memory 706 stores software instructions to enable the operation of the client telephony bridging device 702 according to the present invention. In its operations, the processing circuitry 704 of the client telephony bridging device 702 executes software relating to local call processing and bridging override operations 724, distributed server application operations 725, bridging and billing software application operations 726, remote user/device service permission operations 728, and PSTN to Internet call setup operations 730. When executing the remote user/device service permissions operations 728, the client telephony bridging device 702 determines whether local, national, and/or international connections are allowed for bridging. In its PSTN to Internet call setup operations 730, the client telephony bridging device 702 is operable to interface with a local PSTN device to perform auto-caller ID, touch tone voicemail vectoring operations, and other operations enabling a remote user of the PSTN terminal to interact to the client telephony bridging device 702 via the PSTN interface(s) 710. With these operations, the client telephony bridging device 702 supports the remote enablement of the client telephony bridging device 702 for bridging a PSTN to PSTN or PSTN to VoIP call.

Further, stored in memory 706 are software instructions that enable the client telephony bridging device 702 upon their execution to perform Internet to PSTN call setup operations 732 to PSTN usage billing support operations 734, bridging exchange processing operations 736, and security/encryption processing operations 738. These operations have been previously described with reference to FIG. 3.

FIG. 8 is a block diagram illustrating a client telephony bridging device constructed according to a third embodiment of the present invention. The client telephony bridging device 802 may serve as the set top box 114 of FIG. 1 or set top box 228 of FIG. 2, for example. The client telephony bridging device 802 includes processing circuitry 804, memory 806, communication interface 808, remote control interface 810, built-in user interface 812, and audio/visual system interface 814. The processing circuitry 804 is operable to perform media playback and storage control operations 816 and to perform call manager operations 818 according to the present invention. The processing circuitry 804 may be or include distributed processing circuitry 805 that operates according to the present invention and that was previously described with reference to prior FIGs. and as will be described with reference to subsequent FIGs.

The communication interface 806 includes a wired PSTN out interface 828 that services a downstream PSTN telephone, for example. A cordless PSTN out interface 830 services a cordless handset or other cordless voice communication device that may be serviced by the client telephony bridging device 802. A cellular upstream interface 832 communicatively couples the client telephony bridging device 802 to a cellular network. Wired PSTN upstream interface 834 communicatively couples the client telephony bridging device 802 to a wired PSTN. Wireless headset interface 836 communicatively couples the client telephony bridging device 802 to a wireless headset. Upstream wired/wireless packet data network interface(s) 838 communicatively couples the client telephony bridging device 802 to a wired and/or wireless packet data network. Downstream wired/wireless packet data network interface(s) 840 communicatively couple to client telephony bridging device 802 to a downstream packet data communication network such as a local area network or a wireless local area network. A media programming tuner 842 communicatively couples the client telephony bridging device 802 to a media source provider or media source network. The media programming tuner 842 receives media content via cable modem network, a satellite network, a fixed wireless network, or another network employed by a media contents provider.

Remote control interface 810 allows a user to access the client telephony bridging device 802 via remote control, e.g., remote control 250 of FIG. 2. Built-in user interface(s) 812 may be a keypad, a display, or another interface that allows a user directly to interface the client telephony bridging device 802. The audio/visual system interface 814 communicatively couples the client telephony bridging device 802 to an audio/visual system such as a home entertainment system. The home entertainment system may include a surround sound system and a high definition monitor, e.g., 252 of FIG. 2.

The memory 806 stores software instructions that, upon execution by the processing circuitry 804, enable operation according to the present invention. The software instructions include local call processing with bridging override software instructions 810, distributed server application operations 811, bridging and billing software application instructions 812, remote user/device service permissions software instructions 814, and PSTN to Internet call setup software instructions 816. Further, the memory 806 may also store Internet to PSTN call setup instructions 818, PSTN usage billing support software instructions 820, bridging exchange processing and software instructions 824, and security/encryption processing instructions 826. As is indicated by the names of the software instructions stored in memory 806, upon execution of these software instructions by the processing circuitry 804, the client telephony bridging device 802 performs operations according to the present invention that are previously described and that will be further described with reference to FIGS. 9 and 10.

FIG. 9 is an operational flow diagram illustrating a plurality of VoIP to PSTN telephony operations according to embodiments of the present invention. The operations of FIG. 9 relate to a VoIP to PSTN telephone call. In such case, calling VoIP terminal 904 desires to establish a phone call with receiving PSTN terminal 908. With the operations of FIG. 9, the telephony bridging circuitry 902 of a client telephony bridging device of the present invention bridges the call between the calling VoIP terminal 904 and the receiving PSTN terminal 908.

In a first operation, the calling VoIP terminal 904, knowing the PSTN number of the receiving PSTN terminal 908, sends a VoIP to PSTN service request 912 to a billing and account management server and/or distributed processing circuitry 906. The request sent from the calling VoIP terminal 904 to the billing and account management server and/or distributed processing circuitry 906 may include the IP address of the calling VoIP terminal 904, a handle of a calling subscriber, a handle of the receiving subscriber (of receiving PSTN terminal 908), the PSTN telephone number of receiving PSTN terminal 908, and/or other information. In response, also at 912, the billing and account management server and/or distributed processing circuitry 906 provides the calling VoIP terminal 904 with information regarding the telephony bridging circuitry 902, e.g., the IP address of telephony bridging circuitry 902, and additional information that would allow the calling VoIP terminal 904 to access the telephony bridging circuitry 902. In an alternate operation, the calling VoIP terminal 904 accesses the telephony bridging circuitry 902 directly without requiring interface to the billing and account management server 906. Note that the telephony bridging circuitry 902 is present in one or a multiple of client telephony bridging devices that participate in setting up and servicing the bridged communication.

Next, the calling VoIP terminal 904 sends a VoIP to PSTN bridging request 914 to the telephony bridging circuitry 902. Interaction may occur between the calling VoIP terminal and the telephony bridging circuitry 902 to elicit additional information that will be employed to establish the bridged call. Such information may identify a calling subscriber, a handle/ID of a called party, and/or or other information. In response to the VoIP to PSTN bridging request 914, the telephony bridging circuitry 902 may send a caller/device database record request 918 to client database storage 910, which may be distributed among the plurality of client telephony bridging devices. This record caller/device database record request 918 may provide additional information regarding not only the calling VoIP terminal 904 but the receiving PSTN terminal 908. A response from the client database storage 910 to the telephony bridging circuitry 902 includes billing information, permissions information, security information, override control information, VoIP handles to phone number mapping formation, and additional information 920. For example, when the calling VoIP terminal 904 sends the handle of a user of receiving PSTN terminal 908, the response 920 from the client database storage 910 would provide a PSTN number map to the receiving PSTN terminal 908. Further, the record 920 may provide information to telephony bridging circuitry 908 relating to the security level requirement for the serviced bridge call, whether a local user of telephony bridging circuitry 902 may override bridging for the call during the call, and additional information relating to how the telephony bridging circuitry 902 must treat the bridged call during servicing.

Next, the telephony bridging circuitry 902 performs PSTN call setup interaction 922 with the receiving PSTN terminal 908. Such PSTN call setup interaction 922 may simply be initiating a PSTN call to receiving PSTN terminal 908. Alternately, the PSTN call setup interaction 922 may cause the telephony bridging circuitry 902 to interact with the receiving PSTN terminal 908 to determine whether the receiving PSTN terminal 908 will accept the bridged call. This interaction 922 may include a handle or IP address associated with the calling VoIP terminal 904. Based upon this information, the receiving PSTN terminal 908 may terminate the PSTN call, reject the PSTN call, or ask for additional information.

Once the telephony bridging circuitry 902 establishes the call to the receiving PSTN terminal 908, the call is bridged and completed between the calling VoIP terminal 904 and the receiving PSTN terminal 908. As was previously described with reference to FIGS. 1 and 2, the call will be serviced via the Internet, other packet data network(s), and at least one PSTN network. The telephony bridging circuitry 902 then monitors the PSTN usage for the serviced call. The PSTN usage information may be reported to the billing account management server 906 by the telephony bridging circuitry 902 during or at completion of the PSTN call (operation 924). Such PSTN usage information 924 may include the toll incurred by telephony bridging circuitry 902 in establishing the call to receiving PSTN terminal 908. The billing and account management service 906 uses this information to bill a calling subscriber or to place such charges on account for further processing in a bartering arrangement or in another transaction. The telephony bridging circuitry 902 may receive a caller/device database record 916 from the billing and account management service 908 that provides additional information regarding the calling VoIP terminal 904. This information may be used during call setup, during call servicing, or later when the telephony bridging circuitry 902 desires perhaps to access other telephony bridging circuitry 902.

FIG. 10 is an operational flow diagram illustrating a plurality of PSTN to VoIP telephony operations according to embodiments of the present invention. With these operations, calling PSTN terminal 1004 establishes a call to receiving VoIP terminal 1006 via telephony bridging circuitry 1002. In initiating the call, calling PSTN terminal 1004 sends a PSTN call with bridging indication request 1012 to the telephony bridging circuitry 1002. Note that the telephony bridging circuitry 1002 is present in one or a multiple of client telephony bridging devices that participate in setting up and servicing the bridged communication. In response to this request, the telephony bridging circuitry 1002 interacts with the calling PSTN terminal 1002 to receive information regarding the desired destination of the call. The interaction could be via a keypad interface, a voicemail vectoring interface, a voice recognition system interface, or via another interface allowing the caller using the calling PSTN terminal 1004 to provide sufficient information to the telephony bridging circuitry 1002 to complete the call.

In response to the information received from the calling PSTN terminal 1004 the telephony bridging circuitry 1002 sends a caller/device database record request 1014 to local client storage, distributed processing circuitry, and/or billing and account management servers 1008 and 1010. This request 1014 may include the handle of a subscriber associated with receiving Internet telephony circuitry 1006, and/or additional information. In response, local client storage 1008 and/or the distributed processing circuitry and/or billing and account management server 1010 sends a record 1016 to the telephony bridging circuitry 1002 that includes billing information, permissions information, security information, override control information, VoIP handles to phone number mapping information, and/or additional information. This information enables the telephony bridging circuitry 1002 to determine an IP address of the receiving VoIP terminal 1006.

The telephony bridging circuitry 1002 then sends an Internet call setup request 1018 to the receiving Internet telephony circuitry 1006. In an alternate operation, a first telephony This call setup request 1018 may include Internet call setup interaction with which the telephony bridging circuitry 1002 attempts to establish a VoIP call with a local user of receiving Internet telephony circuitry 1006. The Internet call setup interaction may include the identity of a particular local user of the receiving Internet telephony circuitry 1006 when the receiving Internet telephony circuitry 1006 services a plurality of local users. At such case, the receiving Internet telephony circuitry 1006 would provide the unique announcement corresponding to the particular user or subscriber.

Receiving Internet telephony circuitry 1006 then allows the telephony bridging circuitry 1002 to establish a VoIP call path. The telephony bridging circuitry 1002 also establishes a PSTN call path with the calling PSTN terminal 1004 if such path has not previously been established. Then, the telephony bridging circuitry 1002 bridges the call between the calling PSTN terminal 1004 and receiving Internet telephony circuitry 1006 until it is either completed or interrupted by a local subscriber. As was the case with the previous instruction of FIG. 9, a local subscriber may interrupt the bridged call based upon the particular security and override control settings for the call.

As one of average skill in the art will appreciate, the term “communicatively coupled,” as may be used herein, includes wireless and wired, direct coupling and indirect coupling via another component, element, circuit, or module. As one of average skill in the art will also appreciate, inferred coupling (i.e., where one element is coupled to another element by inference) includes wireless and wired, direct and indirect coupling between two elements in the same manner as “communicatively coupled”.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. In an infrastructure supporting both Voice over Internet Protocol (VoIP) telephony via the Internet and Public Switched Telephone Network (PSTN) telephony via the PSTN, a system comprising:
a plurality of client telephony bridging devices, each communicatively coupled to both the Internet and to the PSTN, each of the plurality of client telephony devices both bridge calls between the Internet and the PSTN, and store PSTN access point information regarding other of the plurality of client telephony bridging devices; and
a first one of the plurality of client telephony bridging devices that receives a call bridging setup request from a calling VoIP terminal, the call bridging request including a PSTN phone number of a destination PSTN terminal;
the first one of the plurality of client telephony bridging devices retrieves PSTN access point information regarding at least one of the plurality of client telephony bridging devices; and
the first one of the plurality of client telephony bridging devices, based upon the PSTN access point information, selects a second one of the plurality of client telephony bridging devices to bridge a call between the calling VoIP terminal and the destination PSTN terminal.

2. The system of claim 1, further comprising a usage server, communicatively coupled to the plurality of client telephony bridging devices, that tracks usage of the plurality of client telephony bridging devices by a plurality of subscribers.

3. The system of claim 2, wherein:
a first of the plurality of subscribers has associated therewith a corresponding first client telephony bridging device; and
the usage server credits the first of the plurality of subscribers in response to use by others of the plurality of subscribers of the first client telephony bridging device.

4. The system of claim 2, wherein the usage server is further operable to maintain billing for the plurality of subscribers using the plurality of client telephony bridging devices.

5. The system of claim 1, wherein at least one of the plurality of client telephony bridging devices is operable to:
track a plurality of subscribers to the system; and
for each of the plurality of tracked subscribers, store at least one current IP address of a VoIP terminal corresponding to the tracked subscriber.

6. The system of claim 1, wherein at least one of the plurality of client telephony bridging devices is operable to:
track a plurality of subscribers to the system; and
for each of the plurality of tracked subscribers, store at least one current PSTN number corresponding to the tracked subscriber.

7. The system of claim 1, further comprising a tracking server communicatively coupled to the Internet and operable to:
track a plurality of subscribers to the system; and
for each of the plurality of tracked subscribers, store at least one current IP address corresponding to the tracked subscriber.

8. The system of claim 1, further comprising a tracking server communicatively coupled to the Internet and operable to:
track a plurality of subscribers to the system; and
for each of the plurality of tracked subscribers, store at least one current PSTN number corresponding to the tracked subscriber.

9. The system of claim 1, wherein the first one of the plurality of client telephony bridging devices is further operable to enable encryption to hide the identity of the second one of the plurality of client telephony bridging devices from the calling VoIP terminal.

10. The system of claim 1, wherein the first one of the plurality of client telephony bridging devices is further operable to enable encryption to mask content of the call from the second one of the plurality of client telephony bridging devices.

11. In an infrastructure supporting both Voice over Internet Protocol (VoIP) telephony via the Internet and Public Switched Telephone Network (PSTN) telephony via the PSTN, a system comprising:
a plurality of client telephony bridging devices, each communicatively coupled to both the Internet and to the PSTN and operable to:
bridge a call between the Internet and the PSTN;
store PSTN access point information regarding at least some of the plurality of client telephony bridging devices; and
a first one of the plurality of client telephony bridging devices operable to:
receive a call bridging setup request from a calling PSTN terminal, the call bridging setup request including a calling PSTN number and a destination PSTN number of a destination PSTN terminal;
retrieve PSTN access point information regarding at least some of the plurality of client telephony bridging devices;
select a second one of the plurality of client telephony bridging devices based upon the PSTN access point information and the destination PSTN number;
bridge the call between the PSTN and the Internet to service the calling PSTN terminal; and
enable the second one of the plurality of client telephony bridging devices to bridge the call between the Internet and the PSTN to support termination of the call to the destination PSTN terminal.

12. In an infrastructure supporting both Voice over Internet Protocol (VoIP) telephony via the Internet and Public Switched Telephone Network (PSTN) telephony via the PSTN, a system comprising:
a plurality of client telephony bridging devices, each communicatively coupled to both the Internet and to the PSTN and operable to:
bridge a call between the Internet and the PSTN;
store PSTN access point information regarding at least some of the plurality of client telephony bridging devices; and a first one of the plurality of client telephony bridging devices operable to:
receive a call bridging setup request from a calling PSTN terminal, the call bridging request including a calling PSTN number and a destination PSTN number of a destination PSTN terminal;
retrieve PSTN access point information regarding at least some of the plurality of client telephony bridging devices;
select a second one of the plurality of client telephony bridging devices based upon the PSTN access point information and the calling PSTN number;
select a third one of the plurality of client telephony bridging devices based upon the PSTN access point information and the destination PSTN number;
enable the second one of the plurality of client telephony bridging devices to bridge the call between the PSTN and the Internet to service the calling PSTN terminal; and
enable the third one of the plurality of client telephony bridging devices to bridge the call between the Internet and the PSTN for termination to the destination PSTN terminal.

13. In an infrastructure supporting both Voice over Internet Protocol (VoIP) telephony via the Internet and Public Switched Telephone Network (PSTN) telephony via the PSTN, a system comprising:
a plurality of client telephony bridging devices, each communicatively coupled to both the Internet and to the PSTN and operable to bridge calls between the Internet and the PSTN; and
server processing circuitry distributed among the plurality of client telephony bridging devices and operable to:
track a plurality of subscribers of the group of subscribers to the system; and
for each of the plurality of tracked subscribers, store at least one current IP address of a VoIP terminal corresponding to the tracked subscriber.

14. The system of claim 13, wherein the server processing circuitry is further operable to, for each of the plurality of tracked subscribers, store at least one current PSTN number of a PSTN terminal corresponding to the tracked subscriber.

15. The system of claim 13, wherein the server processing circuitry is further operable to:
receive a location update from a tracked subscriber; and
update a stored IP address of a corresponding terminal of the tracked subscriber.

16. The system of claim 13, wherein the server processing circuitry is further operable to:
receive a location update from a tracked subscriber; and
update a stored PSTN number of a corresponding terminal of the tracked subscriber.

17. In an infrastructure supporting both Voice over Internet Protocol (VoIP) telephony via the Internet and Public Switched Telephone Network (PSTN) telephony via the PSTN, a system comprising:
a plurality of client telephony bridging devices, each communicatively coupled to both the Internet and to the PSTN and operable to bridge calls between the Internet and the PSTN; and
server processing circuitry distributed among the plurality of client telephony bridging devices and operable to:
store PSTN access point information regarding at least some of the plurality of client telephony bridging devices;
receive a call bridging setup request from a calling VoIP terminal, the call bridging request including a PSTN number of a destination PSTN terminal;
retrieve PSTN access point information regarding at least some of the plurality of client telephony bridging devices;
based upon the PSTN access point information, select one of the plurality of client telephony bridging devices for call bridging; and
direct the calling terminal to the selected one of the plurality of client telephony bridging devices for call bridging between the Internet and the PSTN to access the destination PSTN terminal.

18. The system of claim 17, wherein the server processing circuitry is further operable to track usage of the plurality of client telephony bridging devices by subscribers of the system.

19. The system of claim 17, wherein the server processing circuitry is further operable to track usage of the selected one of the plurality of client telephony bridging devices by the calling VoIP terminal.

20. The system of claim 17, wherein:
each of a group of subscribers of the system has associated therewith a corresponding client telephony bridging device; and
the server processing circuitry is further operable to execute a barter exchange system for the group of subscribers in which usage of the plurality of client telephony bridging devices is bartered.

21. The system of claim 17, wherein the PSTN access point information comprises:
a local area code; and
a local exchange prefix number.

22. The system of claim 17, wherein:
a client telephony bridging device is operable to:
receive a use request by a local subscriber while bridging a voice call for a non-local subscriber; and
report to the server processing circuitry that a local subscriber use request has been received; and
based upon the report, the server processing circuitry operable to initiate handover of the voice call to a differing client telephony bridging device.

23. The system of claim 17, wherein a client telephony bridging device is operable to:
receive a use request by a local subscriber while bridging a voice call for a non-local subscriber;
provide an indication to the non-local subscriber that voice call bridging service will be terminated; and
terminate the voice bridging service for the non-local subscriber; and
provide access to the local subscriber.

24. The system of claim 17, wherein a client telephony bridging device is operable to:
receive a use request by a local subscriber while bridging a voice call for a non-local subscriber;
send a message to the server processing circuitry indicating that the local subscriber has requested use;
receive a response from the server processing circuitry; and
based upon the response, deny use to the local subscriber.

25. The system of claim 17, wherein a particular client telephony bridging device enacts:
a first level of access for a local subscriber; and
a second level of access for a non-local subscriber.

26. The system of claim 17, wherein access rules for a particular client telephony bridging device have:
a first level of access for during a first period of time; and
a second level of access for a second period of time that differs from the first period of time.

27. The system of claim 17, wherein a first client telephony bridging device is operable to:
determine that its local PSTN connection cannot support a PSTN call;
send a request to the server processing circuitry, requesting access to the PSTN via a second client telephony bridging device; and
access the PSTN via the Internet and the second client telephony bridging device.

28. In an infrastructure supporting both Voice over Internet Protocol (VoIP) telephony via the Internet and Public Switched Telephone Network (PSTN) telephony via the PSTN, a system comprising:
a plurality of client telephony bridging devices, each communicatively coupled to both the Internet and to the PSTN and operable to bridge calls between the Internet and the PSTN; and
server processing circuitry distributed among the plurality of client telephony bridging devices and operable to:
store PSTN access point information regarding at least some of the plurality of client telephony bridging devices;
receive a call bridging setup request from a calling PSTN terminal, the call bridging request including a PSTN number of a destination PSTN terminal;
retrieve PSTN access point information regarding at least some of the plurality of client telephony bridging devices;
select a first one of the plurality of client telephony bridging devices for call bridging from the calling PSTN terminal to the Internet based upon the PSTN access point information;
select a second one of the plurality of client telephony bridging devices for call bridging from the Internet to the PSTN based upon the PSTN access point information; and
setup the first and second ones of the plurality of client telephony bridging devices for call bridging.

29. In a system having a plurality of client telephony bridging devices, each communicatively coupled to both the Internet and to the PSTN and operable to support both Voice over Internet Protocol (VoIP) telephony via the Internet and Public Switched Telephone Network (PSTN) telephony via the PSTN, a method comprising:
a first one of the plurality of client telephony bridging devices:
receiving a call bridging setup request from a calling VoIP terminal, the call bridging request including a PSTN number of a destination PSTN terminal;
retrieving PSTN access point information regarding at least some of the plurality of client telephony bridging devices;
based upon the PSTN access point information and the destination PSNT number, selecting a second one of the plurality of client telephony bridging devices for call bridging; and
the second one of the plurality of client telephony bridging devices bridging the call between the Internet and the PSTN to support termination to the destination PSTN terminal.

30. In a system having a plurality of client telephony bridging devices, each communicatively coupled to both the Internet and to the PSTN and operable to support both Voice over Internet Protocol (VoIP) telephony via the Internet and Public Switched Telephone Network (PSTN) telephony via the PSTN, a method comprising a first one of the plurality of client telephony bridging devices:
receiving a call bridging setup request from a calling PSTN terminal, the call bridging request including a calling PSTN number and a destination PSTN number of a destination PSTN terminal;
retrieving PSTN access point information regarding at least some of the plurality of client telephony bridging devices;
selecting a second one of the plurality of client telephony bridging devices based upon the PSTN access point information and the destination PSTN number;
bridging the call between the PSTN and the Internet to service the calling PSTN terminal; and
enabling the second one of the plurality of client telephony bridging devices to bridge the call between the Internet and the PSTN to support termination of the call to the destination PSTN terminal.

31. In a system having a plurality of client telephony bridging devices, each communicatively coupled to both the Internet and to the PSTN and operable to support both Voice over Internet Protocol (VoIP) telephony via the Internet and Public Switched Telephone Network (PSTN) telephony via the PSTN, a method comprising a first one of the plurality of client telephony bridging devices:
receiving a call bridging setup request from a calling PSTN terminal, the call bridging request including a calling PSTN number and a destination PSTN number of a destination PSTN terminal;
retrieving PSTN access point information regarding at least some of the plurality of client telephony bridging devices;
selecting a second one of the plurality of client telephony bridging devices based upon the PSTN access point information and the calling PSTN number;
selecting a third one of the plurality of client telephony bridging devices based upon the PSTN access point information and the destination PSTN number;
enabling the second one of the plurality of client telephony bridging devices to bridge the call between the PSTN and the Internet to service the calling PSTN terminal; and
enabling the third one of the plurality of client telephony bridging devices to bridge the call between the Internet and the PSTN for termination to the destination PSTN terminal.
